(19) United States
(12) Patent Application Publication
(10) Pub. No.: US 2014/0203535 A1
(43) Pub. Date: Jul. 24, 2014

(54) RETRACTABLE CABIN ACCESS SYSTEM FOR MACHINE

(71) Applicant: Caterpillar Inc., Peoria, IL (US)

(72) Inventors: BERNHARD FRANZ ECKL, SCHWARZENFELD (DE); ANTONIU NOPCEA, REGENSBURG (DE); MARKUS FRANZ HERRNDOBLER, BODENWÖHR (DE); PETER JOHANN BÄUML, WEIDEN (DE)

(73) Assignee: Caterpillar Inc., Peoria, IL (US)

(21) Appl. No.: 14/227,024

(22) Filed: Mar. 27, 2014

(51) Int. Cl. B60R 3/02

(52) U.S. Cl. CPC B60R 3/02
USPC 280/166

(57) ABSTRACT

A retractable cabin access system for a machine is disclosed. In the current disclosure, the retractable cabin access system includes a linkage member, a stairway, and a lock mechanism. The linkage member couples to the frame. The stairway is pivotally coupled to the linkage member and moves between an engaged position and a storage position. The stairway includes a fork, a platform and a plurality of steps. The lock mechanism is coupled to the platform and operates in a lock position or an unlock position. The lock mechanism includes a handle, a lock pin, and a spring. The lock mechanism is further holds the stairway in place at either the engaged position or the storage position.

### TECHNICAL FIELD

The present disclosure generally relates to a machine. More specifically, the present disclosure relates to a retractable cabin access system for the machine.

### BACKGROUND

Most machines, such as earthmoving equipments include a cab. A driver operates the machines from the cab. The cab is commonly equipped with controllers, information displays, and other items which the driver may require to operate the machine. Generally the cab of the machine is positioned above a set of front wheels of the machine. This position of the cab is intended to allow the driver to have optimal view and also assists in operating the machine. However, the position of the cab above the set of front wheels makes it difficult for the driver to enter and exit the cab without assistance.

A cabin access system is used to provide access between the ground level and the cab. Traditionally, the cabin access system includes a ladder or steps. Use of a ladder/step as the cabin access system may lead to problems, such as but not limited to storage. Further, mounting the ladder/step along the side of the wheel may also cause trouble while operating the machine. Further, when we use ladder/step as the cabin access system the challenge lies in the fact that there is a little space available beneath the door of the cab. The little space is due to the position of the cab directly above the set of front wheels.

Various solutions have been developed to address the challenges cited above. The present disclosure is directed towards overcoming the above-stated challenges.

### SUMMARY OF THE DISCLOSURE

In the current disclosure, a retractable cabin access system for a machine having a set of front wheels, a frame, and a cab is disclosed. The retractable cabin access system includes a linkage member, a stairway, and a lock mechanism. The stairway further includes a fork, a platform, and a plurality of steps. The lock mechanism further includes a handle, a lock pin, and a spring. The linkage member includes a first end and a second end. The first end is coupled to the frame. The second end includes a coupling eye. The stairway is pivotally coupled to the second end of the linkage member. The stairway is configured to move between an engaged position and a storage position. Further, the fork is pivotally coupled to the coupling eye using a pin. The lock mechanism is configured to selectively lock or unlock the stairway in the engaged position or the storage position. The handle is configured to switch the lock mechanism between a lock position and an unlock position. The lock pin includes a first end and a second end. The first end of the lock pin is coupled to the handle. The second end of the lock pin is configured to act as a latch. The spring is wrapped around the lock pin. The spring is configured to bias the lock pin in the lock position.

Other features and advantages of the disclosure will become apparent to those skilled in the art, upon review of the following detailed description and drawings.

### BRIEF DESCRIPTION OF DRAWINGS

FIG. 1 illustrates a side view of an exemplary machine, in accordance to the concepts of the present disclosure;

FIG. 2 illustrates an exploded view of a retractable cabin access system, in accordance to the concepts of the present disclosure;

FIG. 3 illustrates an exemplary view of the retractable cabin access system in an engaged position, in accordance to the concepts of the present disclosure;

FIG. 4 illustrates an exemplary view of the retractable cabin access system in a storage position, in accordance to the concepts of the present disclosure; and

FIG. 5 illustrates a perspective view of a lock mechanism for the retractable cabin access system, in accordance to the concepts of the present disclosure.

### DETAILED DESCRIPTION

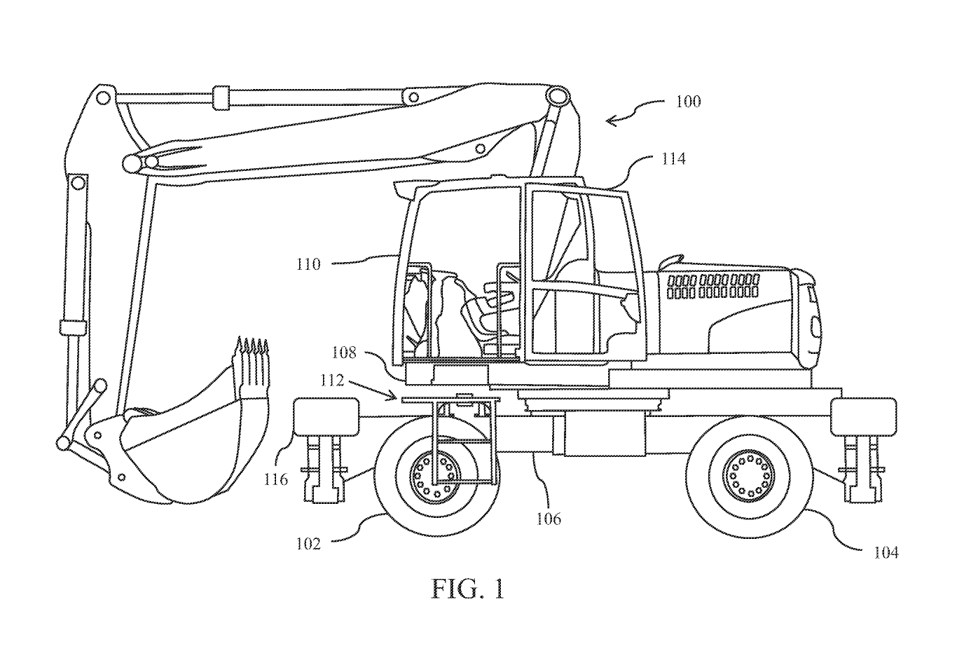

FIG. 1 illustrates a side view of an exemplary machine 100, in accordance to the concepts of the present disclosure. The machine 100 may embody a fixed or a mobile machine that performs various operations associated with an industry such as, but not limited to mining, construction, farming, transportation, or automobile industry. For example, the machine 100 may be an earth moving machine such as a track type excavator, a wheel excavator (as shown in FIG. 1), a shovel, a backhoe, an automobile or a construction machine.

The machine 100 may include a set of front wheels 102, a set of rear wheels 104, a lower frame 106, an upper frame 108, a cab 110, a retractable cabin access system 112, a door 114, and a stabilizer 116. The set of front wheels 102 and the set of rear wheels 104 enable the machine 100 to be mobile. The set of front wheels 102 further provides directional mobility to the machine 100. The lower frame 106 is positioned above the set of front wheels 102 and the set of the rear wheels 104. The lower frame 106 supports the upper frame 108, mechanical components, electrical components of the machine 100 and the retractable cabin access system 112. The upper frame 108 supports the cab 110. The cab 110 includes certain systems, such as control systems, information display systems, and actuating systems. The cab 110 is further provides a safety space for a driver to operate the machine 100. The cab 110 further includes the door 114 to provide access into the cab 110. The retractable cabin access system 112 is positioned between the cab 110 and the set of front wheels 102, when coupled to the lower frame 106. In an embodiment, the retractable cabin access system 112 is positioned between the cab 110 and the set of rear wheels 104.

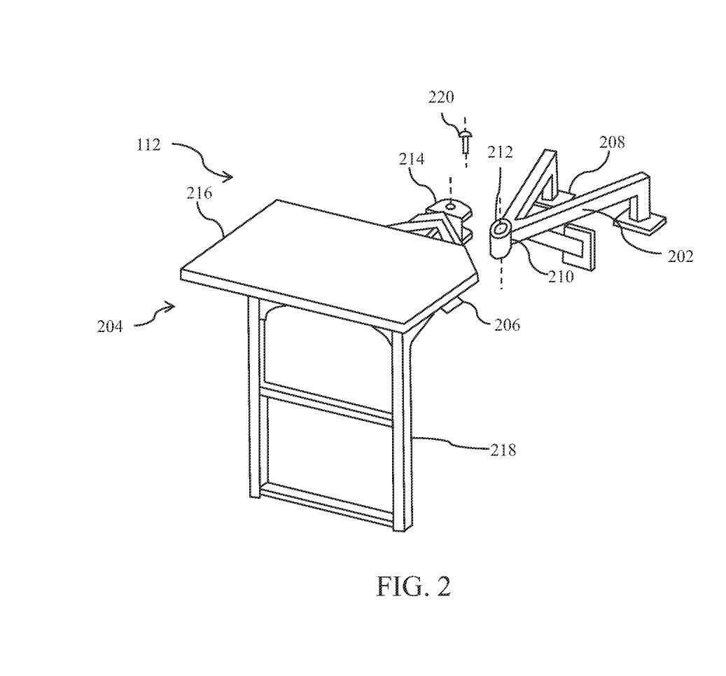

FIG. 2 illustrates an exploded view of the retractable cabin access system 112, in accordance to the concepts of the present disclosure. FIG. 2 is explained in conjunction with elements from FIG. 1. The retractable cabin access system 112 is provides a direct access to the cab 110 of the machine 100. The retractable cabin access system 112 includes a linkage member 202, a stairway 204, and a lock mechanism 206.

The linkage member 202 further includes a first end 208 and a second end 210. The first end 208 of the linkage member 202 is rigidly coupled to the lower frame 106 of the machine 100, thus coupling the retractable cabin access system 112 with the machine 100. In an embodiment, the linkage member 202 is rigidly coupled with the lower frame 106. However, it is evident to a person with ordinary skills in the art that the linkage member 202 is coupled to the lower frame 106 using a weld, nut and bolt or any other technology known in the art. The second end 210 of the linkage member 202 includes a coupling eye 212. In an embodiment, the linkage member 202 includes a plurality of arms. The plurality of arms enables the linkage member 202 to reach the lower frame 106 without interrupting the operations of the other components of the machine 100. In another embodiment, the linkage member 202 is coupled to the lower frame 106, behind a wheel of the set of front wheels 102. This enables the linkage member 202 to be positioned in such a way that the stairway 204 is positioned right below the cab 110 in front of the door 114 in the cab 110.

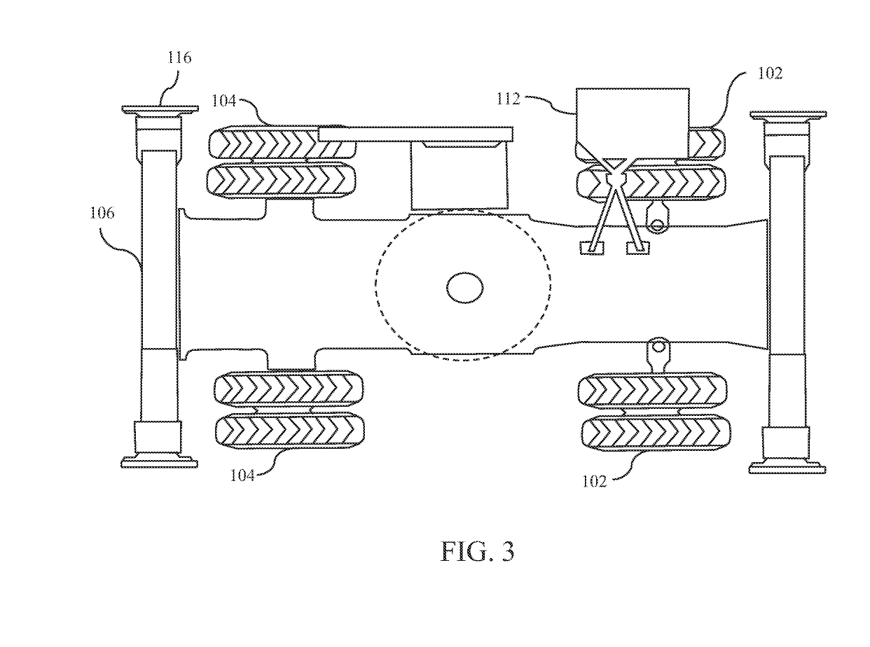

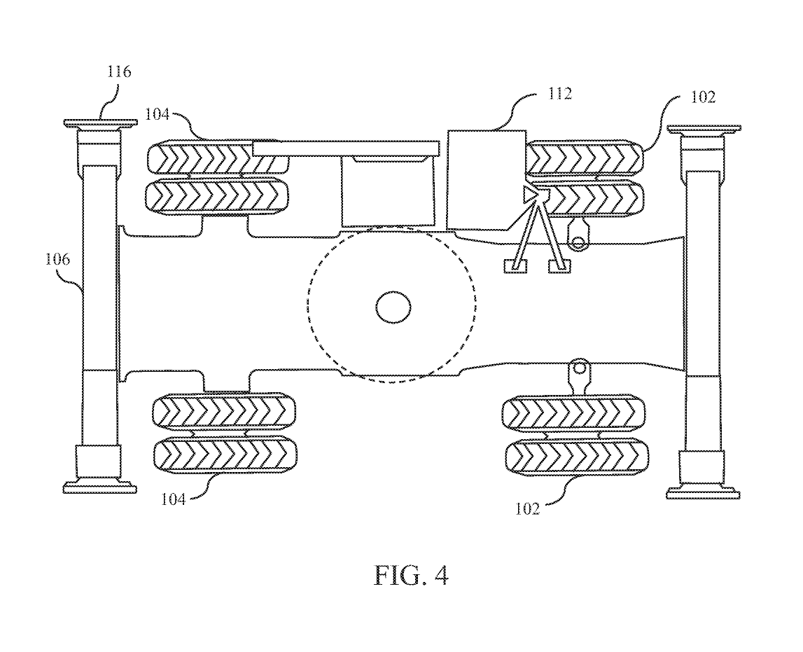

The stairway 204 is pivotally coupled to the second end 210 of the linkage member 202. The stairway 204 moves between an engaged position (as shown in FIG. 3) and a storage position (as shown in FIG. 4). This enables the retractable cabin access system 112 to operate in two modes, namely the engaged position and the storage position. The stairway 204 includes a fork 214, a platform 216, and a plurality of steps 218. The fork 214 is pivotally coupled to the coupling eye using a pin 220. This enables the stairway 204 to move between the engaged position and the storage position. In an embodiment, the platform 216 is rigidly coupled to the fork 214. The platform 216 is enables the driver to open/close and/or lock/unlock the door 114 of the cab 110. The plurality of steps 218 is coupled to the platform 216. The plurality of steps 218 is oriented in a plane substantially perpendicular to a plane of the platform 216. In an embodiment, the plane of the platform 216 is parallel to the ground. The plurality of steps 218 bridges the height/ distance between the ground level/fixed steps and the cab 110. This enables the retractable cabin access system 112 to provide direct access to the cab 110 of the machine 100. However, the person with ordinary skills in the art will appreciate the fact that the stairway 204 can be manufactured from a single work-piece.

FIG. 3 illustrates an exemplary view of the retractable cabin access system 112 in the engaged position, in accordance to the concepts of the present disclosure. FIG. 3 is explained in conjunction with elements from FIG. 1 and FIG. 2. In the engaged position, the stairway 204 of the retractable cabin access system 112 moves in front of the wheel of the set of front wheels 102. In the engaged position, the platform 216 is positioned between the wheel and the cab 110 and in front of the door 114 of the cab 110. In engaged position, the plurality of steps 218 is positioned in front of the wheel. So, the engaged position enables the driver to have direct access to the cab 110.

FIG. 4 illustrates an exemplary view of the retractable cabin access system 112 in the storage position, in accordance to the concepts of the present disclosure. FIG. 4 is explained in conjunction with elements from FIG. 1 and FIG. 2. In the storage position, the stairway 204 of the retractable cabin access system 112 swings behind the set of front wheels 102. In the storage position, the platform 216 is positioned under the cab 110 and the plurality of steps 218 is positioned behind the set of front wheels 102. In an embodiment, while in the storage position the stairway 204 moves in front of the set of front wheels 102 and the stabilizer 116. Within the same embodiment, in the storage position the platform 216 is positioned below the cab 110 and the plurality of steps 218 is positioned between the set of front wheels 102 and the stabilizer 116. The storage position enables unhindered operation of the machine 100 when the retractable cabin access system 112 is not in use.

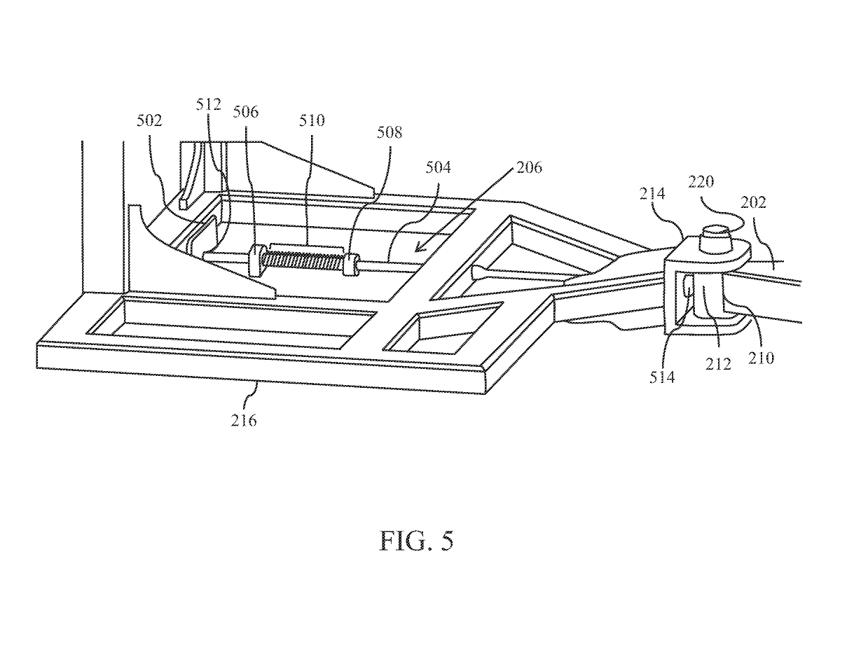

FIG. 5 illustrates a perspective view of the lock mechanism 206 for the retractable cabin access system 112, in accordance to the concepts of the present disclosure. The lock mechanism 206 switches between a lock position and an unlock position. The lock mechanism 206 further holds the stairway 204 in the engaged position or the storage position. In an embodiment, the lock mechanism 206 is positioned under the platform 216. The lock mechanism 206 includes a handle 502, a lock pin 504, a first stopper 506, a second stopper 508, and a spring 510.

The handle 502 switches the lock mechanism 206 between the lock position and the unlock position. The handle 502 is further acts as a man-machine interface for the driver to operate the lock mechanism 206. In an embodiment, the handle 502 is positioned under the platform 216 within the edges of the platform 216. In an embodiment, the handle 502 is positioned under the platform 216 and along the edges of the platform 216. The lock pin 504 includes a first end 512 and a second end 514. The first end 512 of the lock pin 504 is coupled to the handle 502. This enables the lock pin 504 to move when the driver moves the handle 502 in order to operate the lock mechanism 206. The second end 514 of the lock pin acts as a latch. The second end 514 engages with the coupling eye 212 in the lock position. This enables the lock mechanism 206 to keep the stairway 204 in place at either of the engaged position or the storage position. The second end 514 of the lock pin 504 disengages with the coupling eye 212 in the unlock position. This enables the stairway 204 to swing between the engaged position and the storage position. The first stopper 506 is mounted on the platform 216 in proximity to the first end 512 of the lock pin 504. The first stopper 506 holds the lock pin 504 in place. The first stopper 506 includes a through hole which allows the lock pin 504 to pass through it freely. The second stopper 508 is mounted on the lock pin 504 in proximity to the second end 514 of the lock pin 504. The second stopper 508 restricts the spring 510 from moving along the length of the lock pin 504. The spring 510 is wrapped around the lock pin 504 and is positioned between the first stopper 506 and the second stopper 508. The spring 510 biases the lock pin 504 in the lock position. In an embodiment, if the driver moves the handle 502 to switch the lock mechanism 206 from the lock position to the unlock position, then the spring 510 brings back the lock mechanism 206 form the unlock position to the lock position once the driver releases the handle 502.

### INDUSTRIAL APPLICABILITY

In operation, the machine 100 is used for various applications, such as surface mining, construction industry, and the like. The machine 100 is operated from the cab 110. The cab 110 is mounted over the upper frame 108 of the machine 100. The upper frame 108 is supported by the lower frame 106. The lower frame 106 positioned over the set of front wheels 102 and the set of the rear wheels 104. This structure of the machine 100 positions the cab 110 at a height above the ground level. This makes it difficult for the driver to access the cab 110. The retractable cabin access system 112 disclosed focuses on providing the solution for the problem stated above.

The retractable cabin access system 112 operates in the engaged position and the storage position. In the engaged position, the retractable cabin access system 112 moves and is positioned in a way that the plurality of steps 218 is in front of the wheel of the set of front wheels 102 and the platform 216 is between the wheel of the set of the front wheels 102 and the cab 110 in front of the door 114 of the cab 110. The lock mechanism 206 further holds the retractable cabin access system 112 in the engaged position. This enables the driver to have direct access to the cab 110. Thus, the retractable cabin access system 112 allows efficient and direct access to the cab 110. In the storage position, the retractable cabin access system 112 is moved and positioned in a way that the plurality of steps 218 is behind the set of front wheels 102 and the platform 216 is under the cab 110. The lock mechanism 206 again holds the retractable cabin access system 112 in the storage position. This allows the set of front wheels 102 to move freely, thereby, enabling a smooth operation of the machine 100 while in motion. Further, the retractable cabin access system 112 in the storage position may not act as a hindrance during the maintenance of the wheel or other components of the machine 100.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A retractable cabin access system for a machine having a set of front wheels, a frame, and a cab, the retractable cabin access system comprising:
a linkage member having a first end and a second end, wherein the first end is coupled to the frame and the second end includes a coupling eye;
a stairway pivotally coupled to the second end of the linkage member wherein the stairway is configured to move between an engaged position and a storage position, the stairway comprising:
a fork pivotally coupled to the coupling eye using a pin;
a platform; and
a plurality of steps; and
a lock mechanism configured to selectively lock or unlock the stairway in the engaged position or the storage position, the lock mechanism comprising:
a handle configured to switch the lock mechanism between a lock position and an unlock position;
a lock pin having a first end and a second end, wherein the first end is coupled to the handle and the second end is configured to act as a latch; and
a spring wrapped around the lock pin and configured to bias the lock pin in the lock position.
